(19) United States
(12) Patent Application Publication
(10) Pub. No.: US 2021/0001156 A1
(43) Pub. Date: Jan. 7, 2021

(54) A SELF CONTAINED BREATHING APPARATUS CONNECTOR AND METHOD OF MANUFACTURING THEREOF

(71) Applicant: Tony Christopher Keeley, Prescot, Merseyside (GB)

(72) Inventor: Tony Christopher Keeley, Prescot, Merseyside (GB)

(73) Assignee: KEE CONNECTIONS LTD., Prescot, Merseyside (GB)

(21) Appl. No.: 16/970,853

(22) PCT Filed: Oct. 9, 2019
(86) PCT No.: PCT/GB2019/000145

§ 371 Date: Aug. 18, 2020

(30) Foreign Application Priority Data
Oct. 11, 2018 (GB) 1816613.2
Aug. 15, 2019 (GB) 1911737.3

(51) Int. Cl. A62B 9/04; A62B 9/02; F16L 41/02

(52) U.S. Cl. CPC A62B 9/04; A62B 7/02; F16L 41/023; A62B 9/02

(57) ABSTRACT

A self-contained breathing connector apparatus, includes a manifold having a manifold inlet, a first manifold outlet and a second manifold outlet, an inlet connector coupled to the manifold inlet, a first outlet connector coupled to the first manifold outlet, and a second outlet connector coupled to the second manifold outlet. The first outlet connector has a first valve and the second outlet connector has a second valve. The first manifold outlet includes a first valve housing for accommodating at least part of the first valve of the first outlet connector, and the second manifold outlet includes a second valve housing for accommodating at least part of the second valve of the second outlet connector.

### FIELD OF TECHNOLOGY

The present invention relates to Self-Contained Breathing Apparatus (SCBA), and particularly to SCBA buddy breather devices and quick filling/trans filling devices and methods of manufacturing thereof.

### BACKGROUND

SCBAs are used by, for example, firefighters, miners and divers to enable them to breath in a toxic or liquid environment. SCBAs comprise a facemask which is sealed around the user's face. A pressurized air tank, usually carried on the back of a user, provides breathable air into the facemask through a hose connected between the tank and the facemask.

In an event in which a SCBA user's air runs out, becomes low and/or the pressure reduces, an emergency situation is likely to arise in which the user will require air from another source other than their own SCBA.

In such a situation, a Universal Emergency Breathing Safety System (UEBSS), commonly know as a buddy breather device, can be used to enable a second SCBA tank to connect to two separate facemasks thereby providing air to two users. Alternatively, a buddy breather device can be used to provide transfilling of the empty SCBA tank either from the second SCBA tank or from a Rapid Intervention Team air tank.

A buddy breather is a standard piece of kit for use with SCBAs used by, for example, firefighters. A typical buddy breather has an input coupler, for coupling to a source of pressurized air such as from an SCBA tank, and two output couplers, for coupling to two separate user facemasks, thereby enabling the air from one SCBA tank to be shared by two users.

Known buddy breather devices are assembled from three separate types of stand-alone components, namely: a manifold; couplers/plugs; and coupler/plug connectors for connecting the couplers/plugs to the manifold. The buddy breather is attached to a length of hose and stored in a pouch on a user's waste belt for use in emergency situations.

For the benefit of clarity, although the terms connector, coupling and coupler may be used in the industry to describe different aspects of connection, the terms are generally used interchangeably in the industry and that is how they should be construed in the present Application.

SCBAs are generally used in relatively hazardous environments and users, such as firefighters, typically have a significant load of heavy apparatus and tools to carry. Therefore, there is a continuous desire in the industry to develop more compact low-weight equipment and components

Also, buddy breathers are used in emergency situations and therefore their integrity and ability to function effectively and safely without any loss of air is of paramount importance. It is therefore desirable in the industry for there to be as few potential air leakage failures as possible.

The known buddy breathers are relatively heavy and have a number of components requiring seals positioned between the components. The larger the number of seals the greater risk of potential failures and therefore it is desirable to have the minimum number of seal joints between components.

An objective of the present invention is to provide an easy to use, relatively low-weight, compact and effective buddy breather connector which has improved integrity and lower risk of leakage and which is relatively in-expensive to manufacture; and a method of manufacturing such a buddy breather connector.

It is also an objective of the present invention to provide a buddy breather connector which requires less material and resources to manufacture and thereby provides environmental benefits.

### SUMMARY OF INVENTION

According to a first aspect of the present invention there is provided a Self Contained Breathing Apparatus, SCBA, connector, comprising: a manifold having a manifold inlet, a first manifold outlet and a second manifold outlet; an inlet connector coupled to the manifold inlet; a first outlet connector coupled to the first manifold outlet; and a second outlet connector coupled to the second manifold outlet, wherein the first outlet connector comprises a first valve and the second outlet connector comprises a second valve; and wherein the first manifold outlet comprises a first valve housing for accommodating at least part of the first valve of the first outlet connector, and the second manifold outlet comprises a second valve housing for accommodating at least part of the second valve of the second outlet connector.

The first and second outlet connectors may be coupled to the first and second manifold outlets, respectively, using cooperating threads.

The manifold may be formed from a single piece of material.

The manifold may be formed from a material comprising aluminium. Alternatively the manifold is formed from a material comprising brass. Alternatively, the manifold is formed from a material comprising stainless steel.

The inlet coupling may comprise a connection tail, a body and rotation means, wherein in the rotation means is operable to enable rotation of the connection tail relative to the body.

The rotation means may comprise a clip operable to engage with the connection tail and the body to prevent longitudinal movement of the connection tail relative to the body and allow rotation of the connection tail relative to the body.

One of the at least two manifold outlets may be disposed at least substantially on the same longitudinal axis as the inlet.

At least one of the at least two manifold outlets may be disposed at an acute angle relative to the longitudinal axis of the manifold inlet.

According to a second aspect of the present invention, there is provided a method of manufacturing a Self Contained Breathing Apparatus, SCBA, connector, the method comprising: providing a manifold having a manifold inlet and at least a first manifold output and a second manifold outlet; providing an inlet connector and coupling the inlet connector to the manifold inlet; providing a first outlet connector and coupling the first outlet connector to the first manifold outlet; providing a second outlet connector and coupling the second outlet connector to the second manifold outlet; wherein the first outlet connector comprises a first valve and the second outlet connector comprises a second valve; and whereby the method further comprises forming a first valve housing in the first manifold outlet for accommodating the first valve, and forming a second valve housing in the second manifold outlet for accommodating the second valve, such that in an assembled state at least a part of the first valve, of the first outlet connector, is disposed in the first manifold outlet, and at least a part of the second valve, of the second outlet connector, is disposed in the second manifold outlet.

The first and second outlet connectors are coupled to the first and second manifold outlets, respectively, using cooperating threads.

The manifold may be formed from a single piece of material.

The manifold may be formed from a material comprising aluminium. Alternatively, the manifold is formed from a material comprising brass. Alternatively, the manifold is formed from a material comprising stainless steel.

The manifold may be formed by at least one of machining, forging and casting.

At least one of the two or more outlet couplings may comprise a valve operable to automatically close the outlet coupling when not in use.

### DESCRIPTION

Embodiments of the invention will now be described by way of example and with reference to the following drawings, in which:

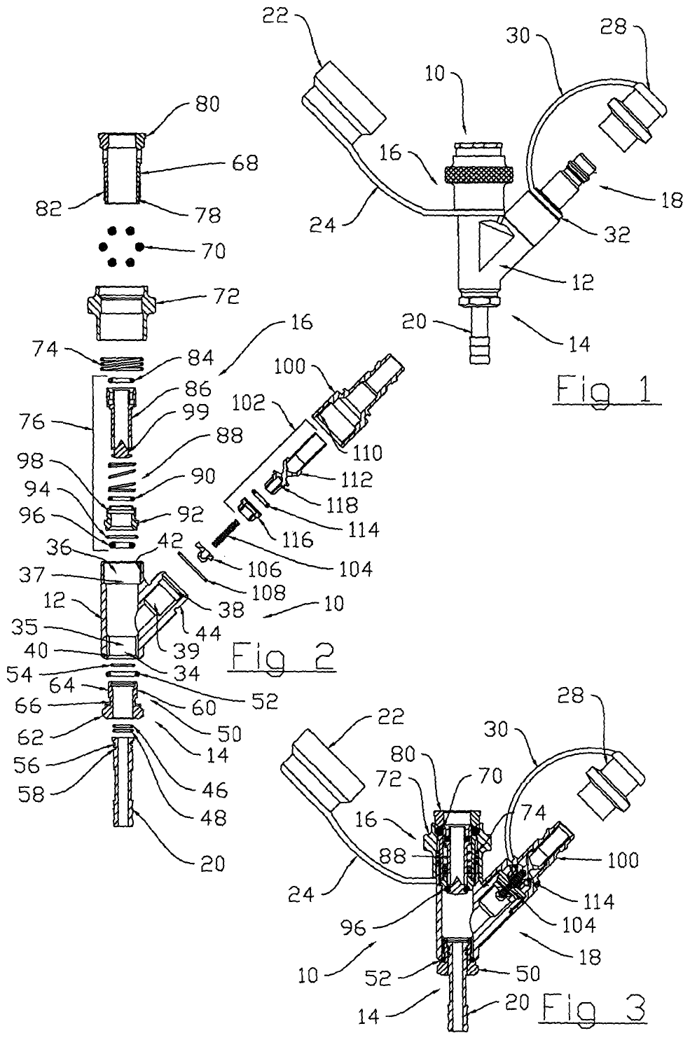

FIG. 1 shows a SCBA connector according to the present invention;

FIG. 2 shows an exploded view of the SCBA connector of FIG. 1;

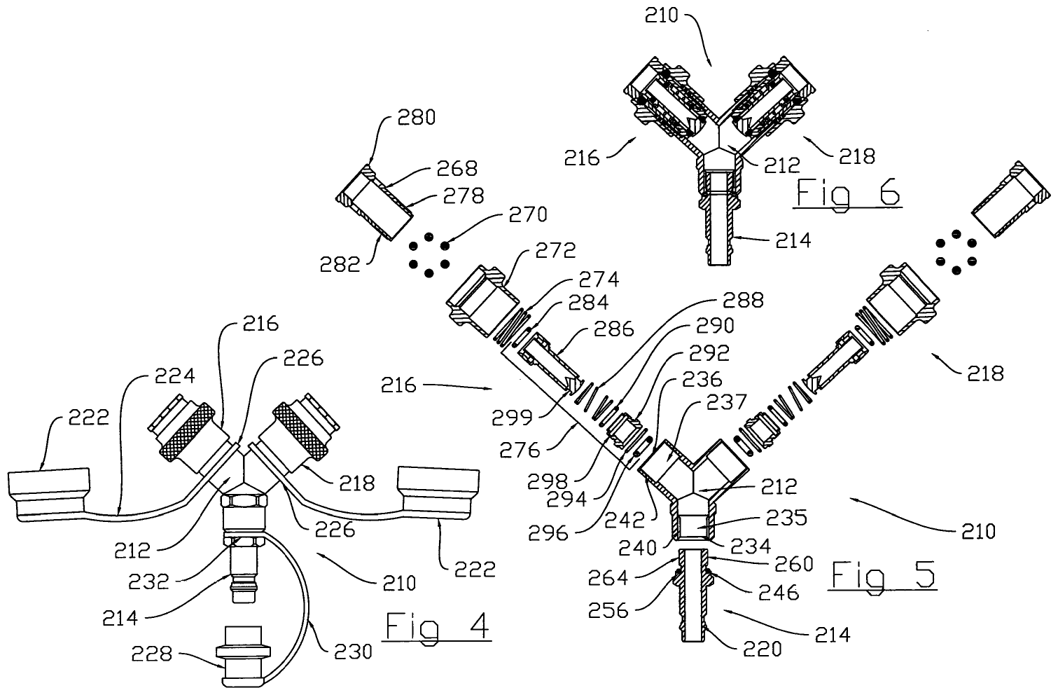

FIG. 3 shows a sectional view through the SCBA connector of FIGS. 1 and 2;

FIG. 4 shows an alternative embodiment of an SCBA connector according to the present invention;

FIG. 5 shows an exploded view of the SCBA connector of FIG. 4; and

FIG. 6 shows a sectional view through the SCBA connector of FIGS. 4 and 5.

Referring to FIGS. 1 and 2, a first embodiment of a SCBA connector 10, according to the present invention, comprises a manifold 12, an inlet connector 14, a first outlet connector 16 and a second outlet connector 18.

The first outlet connector 16 extends in the direction of the longitudinal axis of the inlet connector 14, and the second outlet connector 18 extends at an acute angle relative to the inlet connector 14, in the direction of flow. More preferably, the second outlet connector 18 may extend at an angle of preferably 60° or less relative to the inlet connector 14 and even more preferably at an angle of approximately 45° or less relative to the inlet connector.

In the illustrated embodiment, the first outlet connector 16 is a receiving valve socket and the second outlet connector 18 is a plug. However, in other embodiments the SCBA connector 10 may have a different configuration of outlet connectors, 16 and 18, such as two receiving sockets or two plugs, to suit different systems couplings and applications.

The inlet connector 14 comprises a profiled connection tail 20.

The SCBA connector 10 further comprises a connector socket cap 22 suitably sized and shaped to frictionally fit over the end of the first outlet connector 16. The connector socket cap 22 is disposed on the end of a tether 24 which has a tethering ring 26 attachable around a portion of lesser diameter of the manifold 12 to thereby attach the connector cap 22 to the manifold 12.

Similarly, a connector plug cap 28 is suitably sized and shaped to frictionally fit over the end of the second outlet connector 18. The connector plug cap 28 has a tether 30 which has a tethering ring 32 attachable around a portion of lesser diameter of the manifold 12 to thereby attach the plug cap 28 to the manifold 12.

The connector socket cap 22 is fitted to cover the first outlet connector 16 to prevent dust and debris entering the connector when not in use.

Similarly, the connector plug cap 28 is fitted to cover the second outlet connector 18 to prevent dust and debris entering the connector when not in use.

The manifold 12 is preferably formed of a single material and may comprise aluminum Alternatively, the manifold 12 may comprise brass and/or stainless steel.

The manifold 12 has a manifold inlet 34, a first manifold outlet 36 and a second manifold outlet 38.

The first manifold outlet 36 extends in the direction of the longitudinal axis of the manifold inlet 34, and the second manifold outlet 38 extends at an acute angle relative to the inlet manifold 34, in the direction of flow. More preferably, the second manifold outlet 38 may extend at an angle of preferably 60° or less relative to the manifold inlet 34 and even more preferably at an angle of approximately 45° or less relative to the inlet connector.

The manifold inlet 34 has a thread 40 formed around the inner circumference thereof. The first manifold outlet 36 has a thread 42 formed around the inner circumference thereof and the second manifold outlet 38 has a thread 44 formed around the outer circumference thereof.

The manifold inlet 34 extends into an inlet housing 35 suitably shaped and dimensioned to receive a portion of the inlet connector 14 within the body of the manifold 12 and act as a stop against which the connector can be biased. Similarly, the first manifold outlet 36 and the second manifold outlet 38 extend into a first outlet connector valve housing 37 and second outlet connector valve housing 39, respectively, suitably shaped and dimensioned to receive at least a part of the valve assembly (76, 102) of the first outlet connector 16 and the second outlet connector 18, respectively, within the body of the manifold 12, and act as a stop against which the connector valves can be biased. The first outlet connector valve housing 37 and the second outlet connector valve housing 39 disposed within the body of the manifold 12, enables at least a portion of each of the first outlet connector 16 and the second outlet connector 18 to be accommodated within the body of the manifold 12 and thereby provides an improved unified, smaller and more lightweight SCBA buddy breather device and reduces the required material and cost of manufacture.

The inlet connector 14 comprises a first O-Ring seal 46, a second O-Ring seal 48, a body 50, a third O-Ring seal 52, the profiled connection tail 20, and a retaining clip 54.

The profiled connection tail 20 has first and second external seal receiving grooves, 56 and 58, which extend around the external circumference of the connection tail 20.

The body 50 has an insertion end 60 and an external end 62. The insertion end 60 has a thread 64 disposed on the outer circumference thereof. The external end 62 has an outer surface of increased diameter which may be formed to engage with a tool such as a spanner.

A seal engagement groove 66 is disposed around the outer circumference of the body 50, between the insertion end 60 and the external end 62.

Referring also to FIG. 3, when assembled the first O-Ring seal 46 and the second O-Ring seal 48 are disposed in the first and second external seal receiving grooves, 56 and 58, on the connection tail 20.

The connection tail 20 extends through the body 50 and is locked in position using the retaining clip 54 such as to prevent longitudinal movement of the connection tail relative to the body 50 but allow rotation of the connection tail 20 relative to the body 50.

The third O-Ring seal 52 is disposed in the seal engagement groove 66 of the body 50.

In its assembled state the inlet connector 14 is attached to the manifold by engaging the thread 64, on the insertion end 60 of the body 50, with the thread 40 of the inlet 34 to thereby directly attach the inlet connector 14 into the housing 35 of the manifold 12.

The first outlet connector 16 comprises a ball cage 68, a plurality of ball bearings 70, a sleeve 72, a sleeve spring 74 and a valve assembly 76. The ball cage 68 has an insertion end 78 and an external end 80. A thread 82 is formed on the external surface of the insertion end 78. The external end is formed as a portion of increased external diameter.

The valve assembly 76 comprises a fourth O-Ring seal 84, a valve body 86, a valve spring 88, a fifth O-Ring seal 90, a valve bush 92, a sixth O-Ring 94 and a seventh O-Ring 96.

The valve bush 92 has a seal engagement groove 98 disposed around the external circumference thereof.

The fourth O-Ring 84 is disposed into the front of the valve body 86 to provide a seal for a plug. The fifth O-Ring seal 90 is disposed in the seal engagement groove 98 of the valve bush 92 providing a seal between valve body 86 & valve bush 92. The sixth O-Ring seal 94 is disposed to provide a seal between the ball cage 68 and the valve assembly 76. The seventh O-Ring Seal 96 disposed in groove 99 of the valve body 86 to complete the valve assembly.

The sleeve spring 74 is disposed in the sleeve 72 and over ball cage 68 to keep the ball bearings 70 in position.

The valve assembly 76 is disposed within the ball cage 68.

In an assembled state the thread 82, on the insertion end 78 of the ball cage 68, is engaged with the thread 42, of the first manifold outlet 36, to directly attach the first outlet connector 16 to the manifold 12 such that the inserted portion (e.g. valve assembly 76) of the first outlet connector 16 extends into the valve housing 37. In this assembled state, the valve assembly 76, of the first outlet connector 16, extends into the valve housing 37 and the valve spring 88 is compressed against the wall of the housing 37 to provide a biasing force on the first outlet connector 16 in an outward direction from the manifold 12.

The second outlet connector 18 comprises a profile plug connector 100, a plug valve assembly 102, a valve spring 104, a spring holder 106 and an eighth O-Ring seal 108. The profile plug connector 100 has a thread 110 disposed on the internal surface thereof.

The plug valve assembly 102 comprises a valve body 112, a ninth O-Ring seal 114 and a valve end cap 116. The valve body 112 has a seal engagement groove 118 disposed around its outer circumference.

The valve body 112, ninth O-Ring seal 114 and valve end cap 116 are assembled to provide the plug valve assembly with the ninth O-Ring seal 114 being disposed in the seal engagement groove 118. The valve end cap 116 is disposed over the valve body 112 and screwed down to compress the O-Ring seal 114 and to hold the valve assembly 102 together.

The valve assembly is disposed within the plug connector 100. The valve spring 104 and the spring holder 106 are disposed on the valve assembly 102.

The eighth O-Ring seal 108 is disposed over the external surface over the second manifold outlet 38 and the thread 110, of the plug connector 100, is engaged with the thread 44 on the second manifold outlet 38, to directly attach the second outlet connector 18 to the manifold 12 such that the inserted portion of the second outlet connector 18 extends into the valve housing 39. In this assembled state, the lower portion of the valve assembly 102, of the second outlet connector 18, extends into the valve housing 39 and the spring holder 106 abuts against the wall of the valve housing 39 and the valve spring 88 is compressed between the spring holder 106 and the valve body 112 such as to provide a biasing force on the second outlet connector 18 in an outward direction from the manifold 12.

Referring to FIGS. 4, 5 and 6, a second embodiment of a SCBA connector 210, according to the present invention, comprises a manifold 212, an inlet connector 214, a first outlet connector 216 and a second outlet connector 218. Corresponding reference signs are used for the same or similar features of the first and second embodiments of the invention.

The second embodiment is similar to first embodiment except that it is formed in a Y-shape and the first and second outlet connectors 216 and 218 are both receiving valve sockets. The first and second outlet connectors 216 and 218 and the inlet connector 214 are disposed at an angle of approximately 120° relative to each other. However, the outlets and inlet may be disposed at other angles relative to each other depending on specific requirements and applications.

The manifold 212 has a manifold inlet 234, a first manifold outlet 236 and a second manifold outlet 238. The manifold inlet 234 has a thread 240 formed around the inner circumference thereof. The first manifold outlet 236 has a thread 242 formed around the inner circumference thereof and the second manifold outlet 238 has a thread 244 formed around the inner circumference thereof.

The SCBA connector 210 further comprises a connector socket cap 222 suitably sized and shaped to frictionally fit over the end of the outlet connectors 216 & 218. The connector socket cap 222 is disposed on the end of a tether 224 which has a tethering ring 226 attachable around a portion of lesser diameter of the manifold 212 to thereby attach the connector cap 222 to the manifold 212.

Similarly, a connector plug cap 228 is suitably sized and shaped to frictionally fit over the end of the second outlet connector 214. The connector plug cap 228 has a tether 230 which has a tethering ring 232 attachable around a portion of lesser diameter of the manifold 212 to thereby attach the plug cap 228 to the manifold 212.

Connector socket caps 222 are fitted to cover the first & second outlet connector 216 & 218 to prevent dust and debris entering the connector when not in use.

Similarly, the connector plug cap 228 is fitted to cover the inlet connector 214 to prevent dust and debris entering the connector when not in use.

The inlet connector 214 comprises a first O-Ring seal 246, and a profiled connection plug 220.

The profiled plug tail 220 has a first external seal engagement groove 256 which extends around the external circumference of the connection tail 220. This inlet connector 220 enables rotation of the assembly 10 when connected to a receiving socket connector. However, a rotating inlet connector, as described in the first embodiment, can be alternatively used.

The inlet connector 214 is attached to the manifold 212 by engaging the thread 264, on the insertion end 260 of the profiled connector 220 with the thread 240 of the inlet 234 to thereby directly attach the inlet connector 214 within the housing 235 of the manifold 212.

As described with reference to the first embodiment, the first outlet connector 216 comprises a ball cage 268, a plurality of ball bearings 270, a sleeve 272, a sleeve spring 274 and a valve assembly 276. The ball cage 268 has an insertion end 278 and an external end 280. A thread 282 is formed on the external surface of the insertion end 278. The external end is formed as a portion of increased external diameter.

The valve assembly 276 comprises a second O-Ring seal 284, a valve body 286, a valve spring 288, a third O-Ring seal 290, a valve bush 292, a fourth O-Ring 294 and a fifth O-Ring 296.

The valve bush 292 has a seal engagement groove 298 disposed around the external circumference thereof.

The Second O-ring 284 is disposed into the front of the valve body 286 to provide a seal for a plug. The third O-Ring seal 290 is disposed in the seal engagement groove 298 of the valve bush 292 providing a seal between valve body 286 & valve bush 292. The Fourth O-Ring seal 294 is disposed to provide a seal between the ball cage 268 and the valve assembly 276. The fifth O-Ring Seal 296 disposed in groove 299 of the valve body 286 to complete the valve assembly.

The sleeve spring 274 is disposed in the sleeve 272 and over ball cage 268 to keep the ball bearings 270 in position.

The valve assembly 276 is disposed within the ball cage 268.

In an assembled state the thread 282, on the insertion end 278 of the ball cage 286, is engaged with the thread 242, of the first manifold outlet 236, to directly attach the first outlet connector 216 within the valve housing 237 in the manifold 212. In this assembled state, the lower portion of the valve assembly 276, of the first outlet connector 216, extends into the valve housing 237 and the valve spring 288 is compressed against the wall of the housing 237 to provide a biasing force on the first outlet connector 216 in an outward direction from the manifold 212.

In this embodiment the second outlet connector 218 is identical to the first outlet connector 216 and directly attaches to the second outlet 238 in the same manner in which the first connector is directly attached to the first outlet 236, as described above.

Although the embodiments of the SCBA connector, according to the present invention, have been described having one input and two outputs, other connectors according to the present invention may have any practical number of inputs and/or outputs.

The first and second embodiments of the SCBA connector, 10 and 210, according to the present invention, advantageously provide a relatively compact and light-weight buddy breather device by providing valve housings enabling at least portions of the input and output connectors to be accommodated within the body of the manifold and by providing direct attachment of the inlet and outlet connectors into the manifold thereby providing a relatively lightweight, unitary, integral buddy breather device, removing the need for separate connectors as required in known buddy breather devices.

Moreover, the SCBA connector, 10 and 210, according to the present invention, is easy to use, and is relatively in-expensive to manufacture, requiring less material and resources compared with known SCBA connector devices. The present invention also enables fewer components to be used thereby improving the integrity, lowering the risk of leakage and reducing the length of the connector providing a more compact device.

1-17. (canceled)

18. A self-contained breathing apparatus connector, comprising:
a manifold having a manifold inlet, a first manifold outlet and a second manifold outlet;
an inlet connector coupled to the manifold inlet;
a first outlet connector coupled to the first manifold outlet; and
a second outlet connector coupled to the second manifold outlet,
wherein the first outlet connector comprises a first valve and the second outlet connector comprises a second valve; and
wherein the first manifold outlet comprises a first valve housing for accommodating at least part of the first valve of the first outlet connector, and the second manifold outlet comprises a second valve housing for accommodating at least part of the second valve of the second outlet connector.

19. The self-contained breathing apparatus connector according to claim 18, wherein said first outlet connector and said second outlet connector are coupled to said first manifold outlet and said second manifold outlet, respectively, using cooperating threads.

20. The self-contained breathing apparatus connector according to claim 18, wherein said manifold is formed from a single piece of material.

21. The self-contained breathing apparatus connector according to claim 18, wherein said manifold is formed from a material comprising aluminum.

22. The self-contained breathing apparatus connector according to claim 18, wherein said manifold is formed from a material comprising brass.

23. The self-contained breathing apparatus connector according to claim 18, wherein the manifold is formed from a material comprising stainless steel.

24. The self-contained breathing apparatus connector according to claim 18, wherein said inlet connector comprises a connection tail, a body and rotation means for rotating said connection tail relative to said body.

25. The self-contained breathing apparatus connector according to claim 24, wherein said rotation means comprises a clip engaging said connection tail and said body for preventing longitudinal movement of said connection tail relative to said body and for allowing rotation of said connection tail relative to said body.

26. The self-contained breathing apparatus connector according to claim 18, wherein one of said first manifold outlet or said second manifold outlet is disposed at least substantially on a same longitudinal axis as said manifold inlet.

27. The self-contained breathing apparatus connector according to claim 18, wherein at least one of said first manifold outlet and said second manifold outlet is disposed at an acute angle relative to a longitudinal axis of said manifold inlet.

28. A method for manufacturing a self-contained breathing apparatus connector, comprising the steps of:
providing a manifold having a manifold inlet and at least a first manifold output and a second manifold outlet;
providing an inlet connector and coupling the inlet connector to the manifold inlet;
providing a first outlet connector and coupling the first outlet connector to the first manifold outlet;
providing a second outlet connector and coupling the second outlet connector to the second manifold outlet, wherein the first outlet connector comprises a first valve and the second outlet connector comprises a second valve;
forming a first valve housing in the first manifold outlet for accommodating the first valve; and,
forming a second valve housing in the second manifold outlet for accommodating the second valve, so that in an assembled state at least a part of the first valve, of the first outlet connector, is disposed in the first manifold outlet, and at least a part of the second valve, of the second outlet connector, is disposed in the second manifold outlet.

29. The method for manufacturing a self-contained breathing apparatus connector according to claim 28, wherein said first outlet connector and said second outlet connector are coupled to said first manifold outlet and said second manifold outlet, respectively, using cooperating threads.

30. The method for manufacturing a self-contained breathing apparatus connector according to claim 28, wherein said manifold is formed from a single piece of material.

31. The method for manufacturing a self-contained breathing apparatus connector according to claim 28, wherein said manifold is formed from a material comprising aluminum.

32. The method for manufacturing a self-contained breathing apparatus connector according to claim 28, wherein said manifold is formed from a material comprising brass.

33. The method for manufacturing a self-contained breathing apparatus connector according to claim 28, wherein the manifold is formed from a material comprising stainless steel.

34. The method for manufacturing a self-contained breathing apparatus connector according to claim 28, further comprising the step of forming said manifold by at least one of machining, forging and casting.
